(19) United States
(12) Patent Application Publication
(10) Pub. No.: US 2025/0351886 A1
(43) Pub. Date: Nov. 20, 2025

(54) AEROSOL-GENERATING DEVICE

(71) Applicant: KT&G CORPORATION, Daejeon (KR)

(72) Inventor: Jae Min LEE, Siheung-si (KR)

(73) Assignee: KT&G CORPORATION, Daejeon (KR)

(21) Appl. No.: 19/193,081

(22) Filed: Apr. 29, 2025

(30) Foreign Application Priority Data
May 16, 2024 (KR) 10-2024-0064146

(51) Int. Cl. A24F 40/57; A24F 40/465; A24F 40/51; H05B 6/10

(52) U.S. Cl. CPC A24F 40/57; A24F 40/465; A24F 40/51; H05B 6/108

(57) ABSTRACT

Various embodiments provide an aerosol-generating device capable of performing various controls by detecting a change in capacitance of a receiving portion into which an aerosol-generating article is inserted.

### CROSS-REFERENCE TO RELATED APPLICATION

This application is based on and claims priority under 35 U.S.C. § 119 to Korean Patent Application No. 10-2024-0064146, filed on May 16, 2024, in the Korean Intellectual Property Office, the disclosure of which is incorporated by reference herein in its entirety.

### BACKGROUND

### 1. Field

The disclosure relates to an aerosol-generating device.

### 2. Description of the Related Art

Recently, the demand for alternative methods for overcoming the shortcomings of general cigarettes has increased. For example, there is an increasing demand for a system for generating aerosols by heating a cigarette or an aerosol generating material by using an aerosol generating device, rather than by burning cigarettes. Accordingly, researches on a heating-type aerosol generating device have been actively conducted.

### SUMMARY

Various embodiments provide an aerosol-generating device capable of performing various controls by detecting a change in capacitance of a receiving portion into which an aerosol-generating article is inserted.

Technical problems to be solved through the embodiments of the present disclosure are not limited to the problems described above, and problems not mentioned can be clearly understood by a person having ordinary skill in the art to which the embodiments belong from this specification and the attached drawings.

Additional aspects will be set forth in part in the description which follows and, in part, will be apparent from the description, or may be learned by practice of the presented embodiments of the disclosure.

An aerosol-generating device according to an embodiment includes a housing including a receiving portion into which an aerosol-generating article is inserted, a heater configured to heat the aerosol-generating article inserted into the receiving portion, a sensor arranged apart from the aerosol-generating article inserted into the receiving portion and configured to generate a sensing signal corresponding to a change in capacitance of the receiving portion, and a processor electrically connected to the heater and the sensor and configured to control power supplied to the heater based on a temperature profile including a preheating period and a smoking period, wherein the processor is further configured to receive the sensing signal from the sensor, determine that the aerosol-generating article has been inserted into the receiving portion when the capacitance of the receiving portion exceeds a first reference value, and after determining that the aerosol-generating article has been inserted, determine that the aerosol-generating article has been removed from the receiving portion when the capacitance of the receiving portion is less than a second reference value that is greater than the first reference value.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1 to 3 are diagrams illustrating examples in which an aerosol-generating article is inserted into an aerosol-generating device;

FIGS. 4 and 5 are diagrams illustrating examples of aerosol-generating articles;

FIG. 6 is a schematic diagram for explaining an aerosol-generating device according to an embodiment;

FIG. 7A illustrates a perspective view of a housing of an aerosol-generating device according to an embodiment;

FIG. 7B illustrates a cross-sectional view of the housing of the aerosol-generating device of FIG. 7A, the cross-sectional view being taken along line A-A′ in FIG. 7A;

FIG. 8A illustrates a perspective view of a housing of an aerosol-generating device according to another embodiment;

FIG. 8B illustrates a cross-sectional view of the housing of the aerosol-generating device of FIG. 8A, the cross-sectional view being taken along line A-A′ in FIG. 8A;

FIG. 9A illustrates a perspective view of a housing of an aerosol-generating device according to another embodiment;

FIG. 9B illustrates a cross-sectional view of the housing of the aerosol-generating device of FIG. 9A, the cross-sectional view being taken along line A-A′ in FIG. 9A;

FIG. 10 illustrates an example of the position of an electrode of an aerosol-generating device according to another embodiment;

FIGS. 11A and 11B are graphs showing changes in capacitance of a receiving portion according to an embodiment;

FIGS. 12A and 12B are drawings for explaining a principle by which capacitance decreases after insertion of an aerosol-generating article; and

FIG. 13 is a block diagram of an aerosol-generating device according to an embodiment.

### DETAILED DESCRIPTION

With respect to the terms used to describe in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, a term which is not commonly used can be selected. In such a case, the meaning of the term will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and changes such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

Throughout the specification, the term “puff” refers to an inhalation by a user, which may mean drawing air through the user's mouth or nose into the user's oral cavity, nasal cavity, or lungs.

As used herein, when an expression such as “at least any one” precedes arranged elements, it modifies all elements rather than each arranged element. For example, the expression “at least any one of a, b, and c” should be construed to include a, b, c, or a and b, a and c, b and c, or a, b, and c.

In an embodiment, an aerosol generating device may be a device that generates aerosols by electrically heating a cigarette accommodated in an interior space thereof.

The aerosol generating device may include a heater. In an embodiment, the heater may be an electro-resistive heater. For example, the heater may include an electrically conductive track, and the heater may be heated when currents flow through the electrically conductive track.

The heater may include a tube-shaped heating element, a plate-shaped heating element, a needle-shaped heating element, or a rod-shaped heating element, and may heat the inside or outside of a cigarette according to the shape of a heating element.

A cigarette may include a tobacco rod and a filter rod. The tobacco rod may be formed of sheets, strands, and tiny bits cut from a tobacco sheet. Also, the tobacco rod may be surrounded by a heat conductive material. For example, the heat conductive material may be, but is not limited to, a metal foil such as aluminum foil.

The filter rod may include a cellulose acetate filter. The filter rod may include at least one segment. For example, the filter rod may include a first segment configured to cool aerosols, and a second segment configured to filter a certain component in aerosols.

In another embodiment, the aerosol generating device may be a device that generates aerosols by using a cartridge containing an aerosol generating material.

The aerosol generating device may include a cartridge that contains an aerosol generating material, and a main body that supports the cartridge. The cartridge may be detachably coupled to the main body, but is not limited thereto. The cartridge may be integrally formed or assembled with the main body, and may also be fixed to the main body so as not to be detached from the main body by a user. The cartridge may be mounted on the main body while accommodating an aerosol generating material therein. However, the disclosure is not limited thereto. An aerosol generating material may also be injected into the cartridge while the cartridge is coupled to the main body.

The cartridge may contain an aerosol generating material in any one of various states, such as a liquid state, a solid state, a gaseous state, a gel state, or the like. The aerosol generating material may include a liquid composition. For example, the liquid composition may be a liquid including a tobacco-containing material having a volatile tobacco flavor component, or a liquid including a non-tobacco material.

The cartridge may be operated by an electrical signal or a wireless signal transmitted from the main body to perform a function of generating aerosols by converting the phase of an aerosol generating material inside the cartridge into a gaseous phase. The aerosols may refer to a gas in which vaporized particles generated from an aerosol generating material are mixed with air.

In another embodiment, the aerosol generating device may generate aerosols by heating a liquid composition, and the generated aerosols may be delivered to a user through a cigarette. That is, the aerosols generated from the liquid composition may move along an airflow passage of the aerosol generating device, and the airflow passage may be configured to allow aerosols to be delivered to a user by passing through a cigarette.

In another embodiment, the aerosol generating device may be a device that generates aerosols from an aerosol generating material by using an ultrasonic vibration method. In this case, the ultrasonic vibration method may refer to a method of generating an aerosol by atomizing an aerosol generating material by using ultrasonic vibration generated by a vibrator.

The aerosol generating device may include a vibrator, and the vibrator may generate a short period of vibration to atomize the aerosol generating material. The vibration generated by the vibrator may be an ultrasound vibration, and the frequency band of the ultrasound vibration may be about 100 kHz to about 3.5 MHz, but is not limited thereto.

The aerosol generating device may further include a wick that absorbs the aerosol generating material. For example, the wick may be arranged to wrap at least one area of the vibrator or to be in contact with at least one area of the vibrator.

As the voltage (e.g., AC voltage) is applied to the vibrator, heat and/or ultrasonic vibration may be generated from the vibrator, and the heat and/or ultrasonic vibration generated from the vibrator may be transmitted to the aerosol generating material absorbed into the wick. The aerosol generating material absorbed into the wick may be converted to a gas phase by heat and/or ultrasonic vibration transmitted from the vibrator, and as a result, aerosol may be generated.

For example, the viscosity of the aerosol generating material absorbed into the wick by the heat generated from the vibrator may be lowered, and the aerosol generating material of which the viscosity is lowered by the ultrasonic vibration generated from the vibrator may be divided into fine particles, thereby generating aerosol, but embodiments are not limited thereto.

In another embodiment, the aerosol generating device is a device that generates aerosols by heating an aerosol generating article accommodated in the aerosol generating device in an induction heating method.

The aerosol generating device may include a susceptor and a coil. In an embodiment, the coil may apply a magnetic field to the susceptor. As power is supplied to the coil from the aerosol generating device, a magnetic field may be formed inside the coil. In an embodiment, the susceptor may be a magnetic body that generates heat by an external magnetic field. As the susceptor is positioned inside the coil and a magnetic field is applied to the susceptor, the susceptor generates heat to heat an aerosol generating article. In addition, optionally, the susceptor may be positioned within the aerosol generating article.

In another embodiment, the aerosol generating device may further include a cradle.

The aerosol generating device may configure a system together with a separate cradle. For example, the cradle may charge a battery of the aerosol generating device. Alternatively, the heater may be heated when the cradle and the aerosol generating device are coupled to each other.

Hereinafter, the present disclosure will now be described more fully with reference to the accompanying drawings, in which exemplary embodiments of the present disclosure are shown such that one of ordinary skill in the art may easily work the present disclosure. The disclosure may, however, be embodied in many different forms and should not be construed as being limited to the embodiments set forth herein.

Hereinafter, the present disclosure will now be described more fully with reference to the accompanying drawings, in which exemplary embodiments of the present disclosure are shown such that one of ordinary skill in the art may easily work the present disclosure.

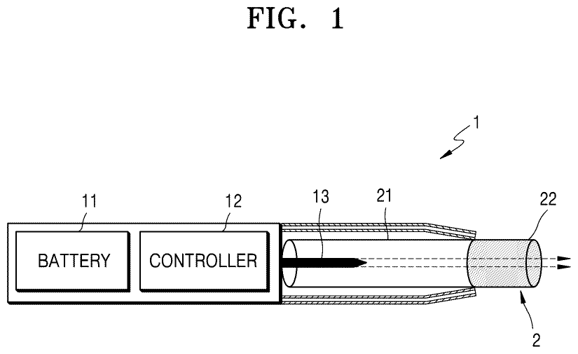

FIGS. 1 through 3 are diagrams showing examples in which an aerosol generating article is inserted into an aerosol generating device.

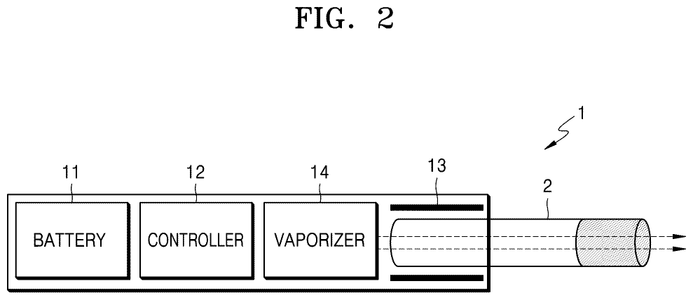

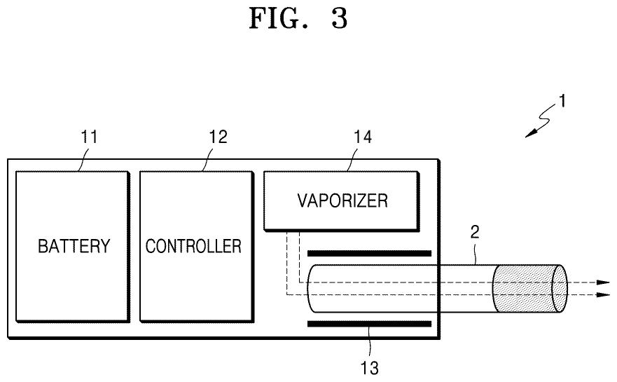

Referring to FIG. 1, the aerosol generating device 1 may include a battery 11, a controller 12, and a heater 13. Referring to FIGS. 2 and 3, the aerosol generating device 1 may further include a vaporizer 14. Also, the aerosol generating article 2 may be inserted into an inner space of the aerosol generating device 1.

FIGS. 1 through 3 illustrate components of the aerosol generating device 1, which are related to the present embodiment. Therefore, it will be understood by one of ordinary skill in the art related to the present embodiment that other general-purpose components may be further included in the aerosol generating device 1, in addition to the components illustrated in FIGS. 1 through 3.

Also, FIGS. 2 and 3 illustrate that the aerosol generating device 1 includes the heater 13. However, as necessary, the heater 13 may be omitted.

FIG. 1 illustrates that the battery 11, the controller 12, and the heater 13 are arranged in series. Also, FIG. 2 illustrates that the battery 11, the controller 12, the vaporizer 14, and the heater 13 are arranged in series. Also, FIG. 3 illustrates that the vaporizer 14 and the heater 13 are arranged in parallel. However, the internal structure of the aerosol generating device 1 is not limited to the structures illustrated in FIGS. 1 through 3. In other words, according to the design of the aerosol generating device 1, the battery 11, the controller 12, the heater 13, and the vaporizer 14 may be differently arranged.

When the aerosol generating article 2 is inserted into the aerosol generating device 1, the aerosol generating device 1 may operate the heater 13 and/or the vaporizer 14 to generate aerosol from the aerosol generating article 2 and/or the vaporizer 14. The aerosol generated by the heater 13 and/or the vaporizer 14 is delivered to a user by passing through the aerosol generating article 2.

As necessary, even when the aerosol generating article 2 is not inserted into the aerosol generating device 1, the aerosol generating device 1 may heat the heater 13.

The battery 11 may supply power to be used for the aerosol generating device 1 to operate. The battery 11 may be a rechargeable battery or a disposable battery. For example, the battery 11 may supply power to heat the heater 13 or the vaporizer 14, and may supply power for operating the controller 12. Also, the battery 11 may supply power for operations of a display, a sensor, a motor, etc. mounted in the aerosol generating device 1.

The controller 12 may generally control operations of the aerosol generating device 1. In detail, the controller 12 may control not only operations of the battery 11, the heater 13, and the vaporizer 14, but also operations of other components included in the aerosol generating device 1. Also, the controller 12 may check a state of each of the components of the aerosol generating device 1 to determine whether or not the aerosol generating device 1 is able to operate.

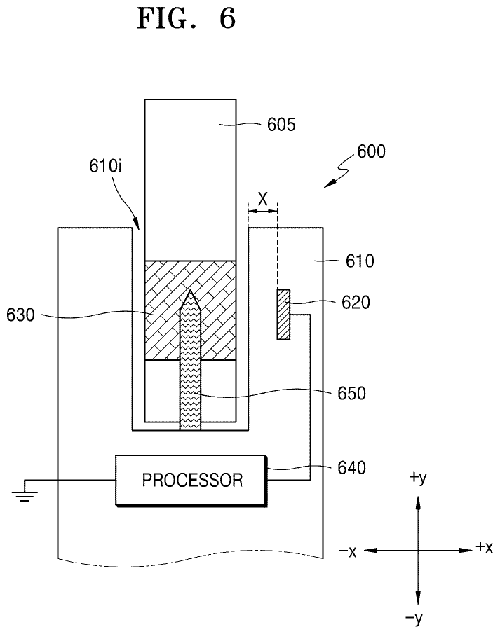

The controller 12 may include at least one processor. The controller 12 can be configured to include the processors of FIG. 6 and FIG. 10 to FIG. 13, which will be described later. A processor can be implemented as an array of a plurality of logic gates or can be implemented as a combination of a general-purpose microprocessor and a memory in which a program executable in the microprocessor is stored. It will be understood by one of ordinary skill in the art that the processor can be implemented in other forms of hardware.

The heater 13 may be heated by the power supplied from the battery 11. For example, when the aerosol generating article 2 is inserted into the aerosol generating device 1, the heater 13 may be located outside the aerosol generating article 2. Thus, the heated heater 13 may increase a temperature of an aerosol generating material in the aerosol generating article 2.

The heater 13 may include an electro-resistive heater. As another example, the heater 13 may include an induction heater. In detail, the heater 13 may include an electrically conductive coil for heating an aerosol generating article in an induction heating method, and the aerosol generating article may include a susceptor which may be heated by the induction heater.

For example, the heater 13 may include a tube-type heating element, a plate-type heating element, a needle-type heating element, or a rod-type heating element, and may heat the inside or the outside of the aerosol generating article 2, according to the shape of the heating element.

Also, the aerosol generating device 1 may include a plurality of heaters 13. Here, the plurality of heaters 13 may be inserted into the aerosol generating article 2 or may be arranged outside the aerosol generating article 2. Also, some of the plurality of heaters 13 may be inserted into the aerosol generating article 2 and the others may be arranged outside the aerosol generating article 2. In addition, the shape of the heater 13 is not limited to the shapes illustrated in FIGS. 1 through 3 and may include various shapes.

The vaporizer 14 may generate aerosol by heating a liquid composition and the generated aerosol may pass through the aerosol generating article 2 to be delivered to a user. In other words, the aerosol generated via the vaporizer 14 may move along an air flow passage of the aerosol generating device 1 and the air flow passage may be configured such that the aerosol generated via the vaporizer 14 passes through the aerosol generating article 2 to be delivered to the user.

For example, the vaporizer 14 may include a liquid storage, a liquid delivery element, and a heating element, but it is not limited thereto. For example, the liquid storage, the liquid delivery element, and the heating element may be included in the aerosol generating device 1 as independent modules.

The liquid storage may store a liquid composition. For example, the liquid composition may be a liquid including a tobacco-containing material having a volatile tobacco flavor component, or a liquid including a non-tobacco material. The liquid storage may be formed to be detachable from the vaporizer 14 or may be formed integrally with the vaporizer 14.

For example, the liquid composition may include water, a solvent, ethanol, plant extract, spices, flavorings, or a vitamin mixture. The spices may include menthol, peppermint, spearmint oil, and various fruit-flavored ingredients, but are not limited thereto. The flavorings may include ingredients capable of providing various flavors or tastes to a user. Vitamin mixtures may be a mixture of at least one of vitamin A, vitamin B, vitamin C, and vitamin E, but are not limited thereto. Also, the liquid composition may include an aerosol forming substance, such as glycerin and propylene glycol.

The liquid delivery element may deliver the liquid composition of the liquid storage to the heating element. For example, the liquid delivery element may be a wick such as cotton fiber, ceramic fiber, glass fiber, or porous ceramic, but is not limited thereto.

The heating element is an element for heating the liquid composition delivered by the liquid delivery element. For example, the heating element may be a metal heating wire, a metal hot plate, a ceramic heater, or the like, but is not limited thereto. In addition, the heating element may include a conductive filament such as nichrome wire and may be positioned as being wound around the liquid delivery element. The heating element may be heated by a current supply and may transfer heat to the liquid composition in contact with the heating element, thereby heating the liquid composition. As a result, aerosol may be generated.

For example, the vaporizer 14 may be referred to as a cartomizer or an atomizer, but it is not limited thereto.

The aerosol generating device 1 may further include general-purpose components in addition to the battery 11, the controller 12, the heater 13, and the vaporizer 14. For example, the aerosol generating device 1 may include a display capable of outputting visual information and/or a motor for outputting haptic information. Also, the aerosol generating device 1 may include at least one sensor (a puff sensor, a temperature sensor, an aerosol generating article insertion detecting sensor, etc.). Also, the aerosol generating device 1 may be formed as a structure that, even when the aerosol generating article 2 is inserted into the aerosol generating device 1, may introduce external air or discharge internal air.

Although not illustrated in FIGS. 1 through 3, the aerosol generating device 1 and an additional cradle may form together a system. For example, the cradle may be used to charge the battery 11 of the aerosol generating device 1. Alternatively, the heater 13 may be heated when the cradle and the aerosol generating device 1 are coupled to each other.

The aerosol generating article 2 may be similar to a general combustive cigarette. For example, the aerosol generating article 2 may be divided into a first portion including an aerosol generating material and a second portion including a filter, etc. Alternatively, the second portion of the aerosol generating article 2 may also include an aerosol generating material. For example, an aerosol generating material made in the form of granules or capsules may be inserted into the second portion. The aerosol generating material may have a certain dielectric constant. The dielectric constant may refer to the ratio of the dielectric constant of a specific material to the dielectric constant of a vacuum. The dielectric constant of air at room temperature and room pressure may be approximately 1.0006, and the dielectric constant of pure water may be approximately 80.4. Since the aerosol generating material may be a solution in which various substances are dissolved in water or other liquid solvents, the aerosol generating material may also have a relatively high dielectric constant compared to the dielectric constant of air.

The entire first portion may be inserted into the aerosol generating device 1, and the second portion may be exposed to the outside. Alternatively, only a portion of the first portion may be inserted into the aerosol generating device 1, or the entire first portion and a portion of the second portion may be inserted into the aerosol generating device 1. The user may puff aerosol while holding the second portion by the mouth of the user. In this case, the aerosol is generated by the external air passing through the first portion, and the generated aerosol passes through the second portion and is delivered to the user's mouth.

For example, the external air may flow into at least one air passage formed in the aerosol generating device 1. For example, opening and closing of the air passage and/or a size of the air passage formed in the aerosol generating device 1 may be adjusted by the user. Accordingly, the amount and the quality of smoking may be adjusted by the user. As another example, the external air may flow into the aerosol generating article 2 through at least one hole formed in a surface of the aerosol generating article 2.

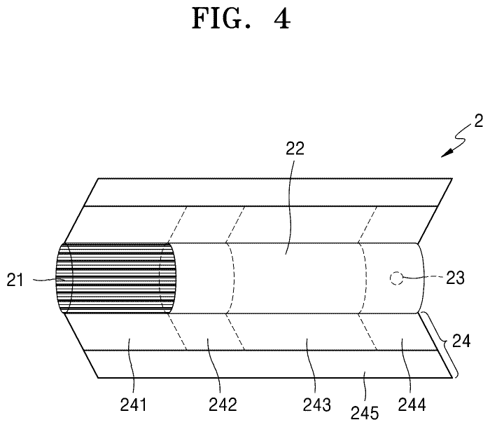

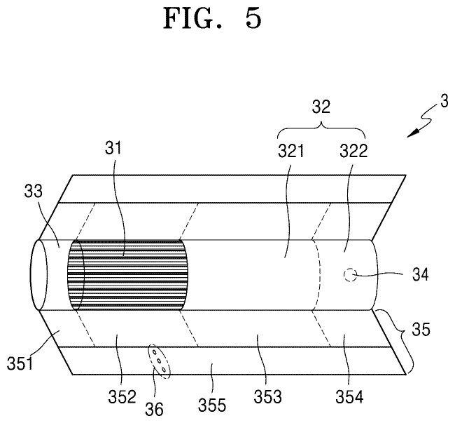

Hereinafter, the examples of the aerosol generating article 2 will be described with reference to FIGS. 4 and 5.

FIGS. 4 and 5 illustrate examples of the aerosol generating article.

Referring to FIG. 4, the aerosol generating article 2 may include a tobacco rod 21 and a filter rod 22. The first portion described above with reference to FIGS. 1 through 3 may include the tobacco rod 21, and the second portion may include the filter rod 22.

FIG. 4 illustrates that the filter rod 22 includes a single segment. However, the filter rod 22 is not limited thereto. In other words, the filter rod 22 may include a plurality of segments. For example, the filter rod 22 may include a first segment configured to cool an aerosol and a second segment configured to filter a certain component included in the aerosol. Also, as necessary, the filter rod 22 may further include at least one segment configured to perform other functions.

The aerosol generating article 2 may be packaged using at least one wrapper 24. The wrapper 24 may have at least one hole through which external air may be introduced or internal air may be discharged. For example, the aerosol generating article 2 may be packaged by one wrapper 24. As another example, the aerosol generating article 2 may be doubly packaged by two or more wrappers 24. For example, the tobacco rod 21 may be packaged by a first wrapper 241, and the filter rod 22 may be packaged by wrappers 242, 243, 244. Also, the entire aerosol generating article 2 may be re-packaged by another single wrapper 245. When the filter rod 22 includes a plurality of segments, each segment may be packaged by wrappers 242, 243, 244.

The tobacco rod 21 may include an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. Also, the tobacco rod 21 may include other additives, such as flavors, a wetting agent, and/or organic acid. Also, the tobacco rod 21 may include a flavored liquid, such as menthol or a moisturizer, which is injected to the tobacco rod 21.

The tobacco rod 21 may be manufactured in various forms. For example, the tobacco rod 21 may be formed as a sheet or a strand. Also, the tobacco rod 21 may be formed as a pipe tobacco, which is formed of tiny bits cut from a tobacco sheet. Also, the tobacco rod 21 may be surrounded by a heat conductive material. For example, the heat conductive material may be, but is not limited to, a metal foil such as aluminum foil. For example, the heat conductive material surrounding the tobacco rod 21 may uniformly distribute heat transmitted to the tobacco rod 21, and thus, the heat conductivity applied to the tobacco rod may be increased and taste of the tobacco may be improved. Also, the heat conductive material surrounding the tobacco rod 21 may function as a susceptor heated by the induction heater. Here, although not illustrated in the drawings, the tobacco rod 21 may further include an additional susceptor, in addition to the heat conductive material surrounding the tobacco rod 21.

The filter rod 22 may include a cellulose acetate filter. Shapes of the filter rod 22 are not limited. For example, the filter rod 22 may include a cylinder-type rod or a tube-type rod having a hollow inside. Also, the filter rod 22 may include a recess-type rod. When the filter rod 22 includes a plurality of segments, at least one of the plurality of segments may have a different shape.

Also, the filter rod 22 may include at least one capsule 23. Here, the capsule 23 may generate a flavor or an aerosol. For example, the capsule 23 may have a configuration in which a liquid containing a flavoring material is wrapped with a film. For example, the capsule 23 may have a spherical or cylindrical shape, but is not limited thereto.

Referring to FIG. 5, the aerosol generating article 3 may further include a front-end plug 33. The front-end plug 33 may be located on one side of the tobacco rod 31 which is opposite to the filter rod 32. The front-end plug 33 may prevent the tobacco rod 31 from being detached outwards and prevent the liquefied aerosol from flowing from the tobacco rod 31 into the aerosol generating device (1 of FIGS. 1 through 3), during smoking.

The filter rod 32 may include a first segment 321 and a second segment 322. Here, the first segment 321 may correspond to the first segment of the filter rod 22 of FIG. 4, and the second segment 322 may correspond to the second segment of the filter rod 22 of FIG. 4.

A diameter and a total length of the aerosol generating article 3 may correspond to a diameter and a total length of the aerosol generating article 2 of FIG. 4. For example, the length of The front-end plug 33 is about 7 mm, the length of the tobacco rod 31 is about 15 mm, the length of the first segment 321 is about 12 mm, and the length of the second segment 322 is about 14 mm, but it is not limited thereto.

The aerosol generating article 3 may be packaged using at least one wrapper 35. The wrapper 35 may have at least one hole through which external air may be introduced or internal air may be discharged. For example, the front end plug 33 may be packaged by a first wrapper 351, the tobacco rod 31 may be packaged by a second wrapper 352, the first segment 321 may be packaged by a third wrapper 353, and the second segment 322 may be packaged by a fourth wrapper 354. Further, the entire aerosol generating article 3 may be repackaged by a fifth wrapper 355.

In addition, at least one perforation 36 may be formed in the fifth wrapper 355. For example, the perforation 36 may be formed in a region surrounding the tobacco rod 31, but is not limited thereto. The perforation 36 may serve to transfer heat generated by the heater 13 illustrated in FIGS. 2 and 3 to the inside of the tobacco rod 31.

In addition, at least one capsule 34 may be included in the second segment 322. Here, the capsule 34 may generate a flavor or an aerosol. For example, the capsule 34 may have a configuration in which a liquid containing a flavoring material is wrapped with a film. For example, the capsule 34 may have a spherical or cylindrical shape, but is not limited thereto.

FIG. 6 is a schematic diagram for explaining an aerosol-generating device 600 according to an embodiment.

The aerosol-generating device 600 may include a housing 610, a receiving portion 610i in which an aerosol-generating article 605 is received, a sensor 620, a processor 640, and a heater 650. The aerosol-generating article 605 may have the same configuration as an example of the aerosol-generating articles 2 and 3 described with reference to FIGS. 1 to 5. The processor 640 may be included as a component of the controller 12 described with reference to FIGS. 1 to 3.

The housing 610 may correspond to a cylinder shape including an outer surface and an inner surface. In this case, the receiving portion 610i may refer to a space surrounded by the inner surface of the housing 610 or may refer to an area corresponding to the inner surface of the housing 610. However, the shape of the housing 610 is not limited thereto and may be variously changed according to the design of the manufacturer.

In an embodiment, the sensor 620 may be arranged to be apart from the inner surface of the housing 610 in a direction toward the outer surface of the housing 610. For example, the housing 610 may extend in a first direction (e.g., the +y direction), and the sensor 620 may be arranged to be apart from the inner surface of the housing 610 in a direction (e.g., the +x direction) perpendicular to the first direction. In addition, the sensor 620 may be arranged to be embedded between the inner surface and the outer surface of the housing 610 by being apart from the inner surface of the housing 610 by a certain distance x.

As the sensor 620 is arranged inside the housing 610, the noise of a data measurement result measured by the processor 640 through the sensor 620 may be reduced. For example, when the sensor 620 is arranged to be exposed to the outside and comes into contact with the aerosol-generating article 605, the sensor 620 may be affected in data measurement by external substances (e.g., tobacco leaves, dust, etc.) In contrast, the sensor 620 according to the disclosure is arranged to be embedded in the interior of the housing 610 or is not exposed to the outside by a separate protective layer, so that contamination by external substances does not occur, thereby reducing noise in data measurement.

In an embodiment, when the aerosol-generating article 605 is inserted into a part (e.g., the receiving portion 610i) of the aerosol-generating device 600, the sensor 620 may be positioned a certain distance away from the inserted aerosol-generating article 605. For example, the certain distance may refer to a distance at which a change in the charging time or discharging time of the sensor 620 caused by the aerosol-generating article 605 may be detected. In an embodiment, the sensor 620 may be positioned to correspond to at least one area of the inserted aerosol-generating article 605. For example, the sensor 620 may be arranged to correspond to at least one area where an aerosol-generating material of the aerosol-generating article 605 is placed.

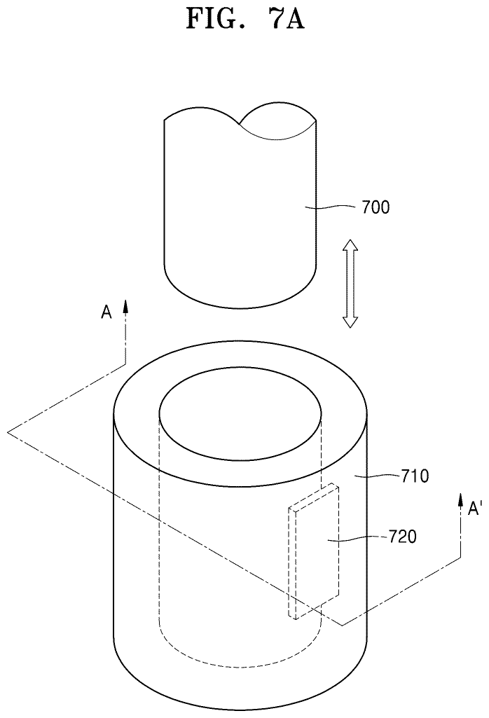

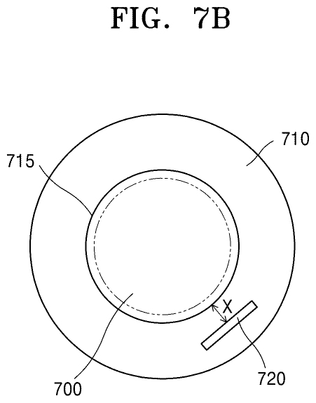

The sensor 620 may generate a sensing signal corresponding to a change in the capacitance of the receiving portion 610i. The sensor 620 may be arranged to correspond to at least one area where an aerosol-generating material 630 is placed. For example, the position of the sensor 620 may correspond to an area where the aerosol-generating material 630 is placed as the aerosol-generating article 605 is fully inserted into the receiving portion 610i of the aerosol-generating device 600. The sensor 620 may be arranged to be apart from the aerosol-generating article 605 inserted into the receiving portion 610i and may include at least one electrode positioned to correspond to an area of the aerosol-generating article 605. The at least one electrode may form a plate of a capacitor. The sensor 620 may perform charging and discharging of the electrode. The specific shape of the electrode will be described below with reference to FIGS. 7 to 9.

The processor 640 may perform a function of determining whether the aerosol-generating article 605 is inserted/removed based on a sensing signal received from the sensor 620 and a function of controlling power supplied to the heater 650 depending on whether the aerosol-generating article 605 is inserted/removed.

In an embodiment, the processor 640 may apply a certain voltage to the sensor 620 and measure the charging time of the sensor 620. The processor 640 may perform various functions based on the measured charging time of the sensor 620 or a change in the charging time. For another example, the processor 640 may also measure the discharging time of the sensor 620 as the sensor 620 naturally discharges. That is, when the charging voltage of the sensor 620 is the same as an applied voltage, the processor 640 may measure the discharging time of the sensor 620 and determine the capacitance of the receiving portion 610i based on the measured charging time or discharging time of the sensor 620.

In an embodiment, the processor 640 may determine the capacitance of the receiving portion 610i based on at least one of the number of times the sensor 620 is charged per unit time and the number of times the sensor 620 is discharged per unit time. The processor 640 may determine the capacitance to decrease in response to an increase in the number of times the sensor 620 is charged or discharged per unit time.

In an embodiment, the processor 640 may determine the capacitance of the receiving portion 610i based on at least one of the charging time or the discharging time of the sensor 620 per unit number of times. The processor 640 may determine the capacitance to increase in response to an increase in the charging time or the discharging time of the sensor 620 per unit number of times.

In an embodiment, the heater 650 may correspond to an internal heating type heater that heats the inside of the aerosol-generating article 605 and may have the same configuration as the heater 13 of FIG. 1. However, this is only an example, and the aerosol-generating device 600 may also be configured with an external heating type heater that heats the outside of the aerosol-generating article 605, such as the heater 13 of FIGS. 2 and 3.

FIG. 7A illustrates a perspective view of a housing of an aerosol-generating device according to an embodiment. FIG. 7B illustrates a cross-sectional view of the housing of the aerosol-generating device of FIG. 7A, the cross-sectional view being taken along line A-A′ in FIG. 7A. FIGS. 7A and 7B may correspond to specific examples of the sensor 620 included in the aerosol-generating device 600 of FIG. 6.

Referring to FIGS. 7A and 7B, a receiving portion 715 is a space surrounded by an inner surface of a housing 710, in which an aerosol-generating article 700 may be received. In an embodiment, a sensor 720 may be an electrode having a shape of a plate without a curvature. In an embodiment, the sensor 720 may be arranged at a certain distance from the receiving portion 715. In this case, because the sensor 720 is in the form of a plate having no curvature, a center portion of the sensor 720 may be apart from the receiving portion 715 by x, and an end portion of the sensor 720 may be apart from the receiving portion 715 by more than x. In order to reduce the difference between the distance between the receiving portion 715 and the center portion of the sensor 720 and the distance between the receiving portion 715 and the end portion of the sensor 720, the width of the sensor 720 may be formed to be substantially narrow.

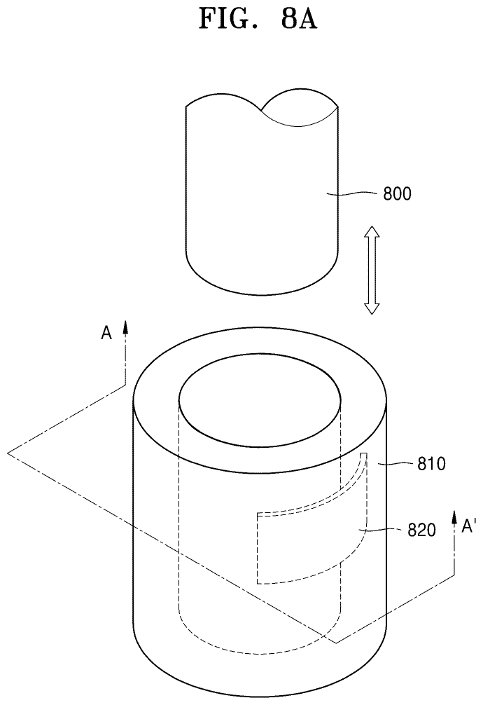

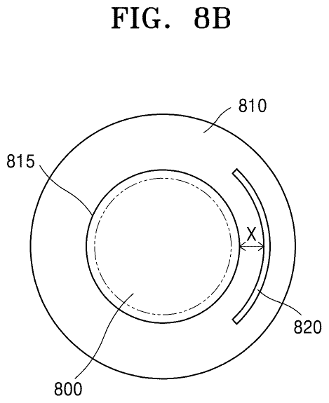

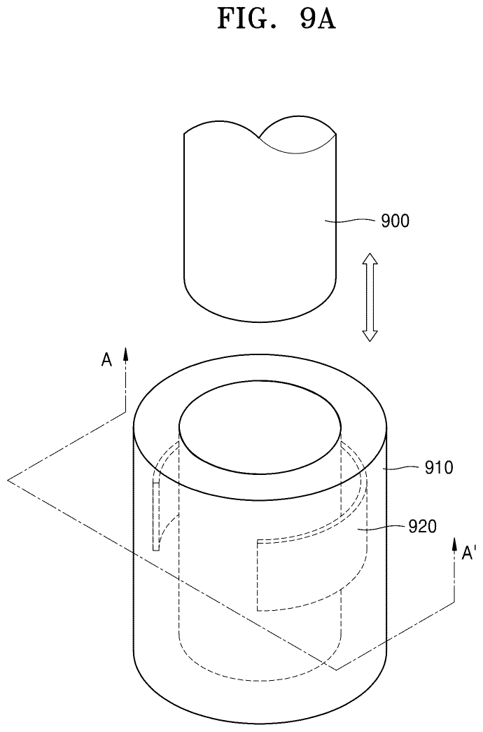

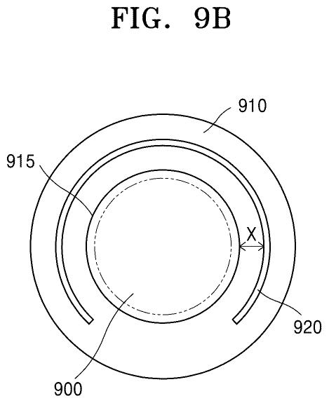

FIG. 8A illustrates a perspective view of a housing of an aerosol-generating device according to another embodiment. FIG. 8B illustrates a cross-sectional view of the housing of the aerosol-generating device of FIG. 8A, the cross-sectional view being taken along line A-A′ in FIG. 8A. FIG. 9A illustrates a perspective view of a housing of an aerosol-generating device according to another embodiment. FIG. 9B illustrates a cross-sectional view of the housing of the aerosol-generating device of FIG. 9A, the cross-sectional view being taken along line A-A′ in FIG. 9A. FIGS. 8A, 8B, 9A, and 9B may correspond to specific examples of the sensor 620 included in the aerosol-generating device 600 of FIG. 6.

Referring to FIGS. 8A, 8B, 9A, and 9B, receiving portions 815 and 915 are spaces surrounded by inner surfaces of housings 810 and 910, in which aerosol-generating articles 800 and 900 may be received, respectively. In an embodiment, the sensor (820, 920) may be an electrode having a plate shape with a specific curvature. For example, sensors 820 and 920 may have curvatures that are smaller than the curvatures of the inner surfaces of the housings 810 and 910 and larger than the curvatures of the outer surfaces of the housings 810 and 910, respectively. When the sensors 820 and 920 are each in the form of a plate having a curvature, all portions (e.g., center portions and end portions) of the sensors 820 and 920 may be arranged to be apart from the receiving portions 815 and 915 by a certain distance, respectively.

In an embodiment, the sensors 820 and 920 may be arranged to be apart from the receiving portions 815 and 915 by a certain distance x and surround at least portions of the receiving portions 815 and 915, respectively. For example, as shown in FIGS. 8A and 8B, the sensor 820 may be arranged to surround only a region corresponding to a portion (e.g., 25%) of the perimeter of the receiving portion 815. For example, as shown in FIGS. 9A and 9B, the sensor 920 may be arranged to surround a region corresponding to a portion (e.g., 90%) of the perimeter of the receiving part 915. However, the regions surrounded by the sensors 820 and 920 are not limited thereto.

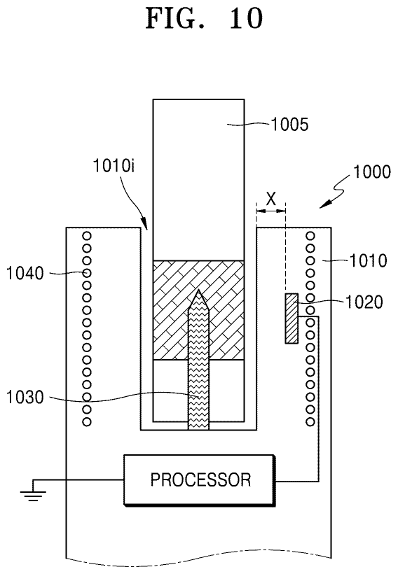

FIG. 10 illustrates an example of the position of an electrode of an aerosol-generating device 1000 according to another embodiment. FIG. 10 may correspond to a specific example of the heater 650 included in the aerosol-generating device 600 of FIG. 6. FIG. 10 includes a heater heated by an induction heating method, and additionally includes an induction coil 1040 in comparison with FIG. 6.

In an embodiment, the heater may include an internal heating type heater 1030 and an induction coil 1040. The induction coil 1040 may generate an alternating magnetic field to induce the internal heating type heater 1030 of the aerosol-generating device 1000 to generate heat. In this case, the internal heating type heater 1030 may correspond to an example of a susceptor. The internal heating type heater 1030 may generate heat by a magnetic field generated from the induction coil 1040 and may heat an aerosol-generating article 1005 inserted into a receiving portion 1010i.

In an embodiment, a sensor 1020 may be arranged between the inner surface of a housing 1010 and the induction coil 1040. In an embodiment, the sensor 1020 may be formed so as not to affect a variable magnetic field generated from the induction coil 1040. For example, in order to prevent the intensity of the variable magnetic field generated by the induction coil 1040 from being reduced, the width of the sensor 1020 may be formed to be substantially narrow.

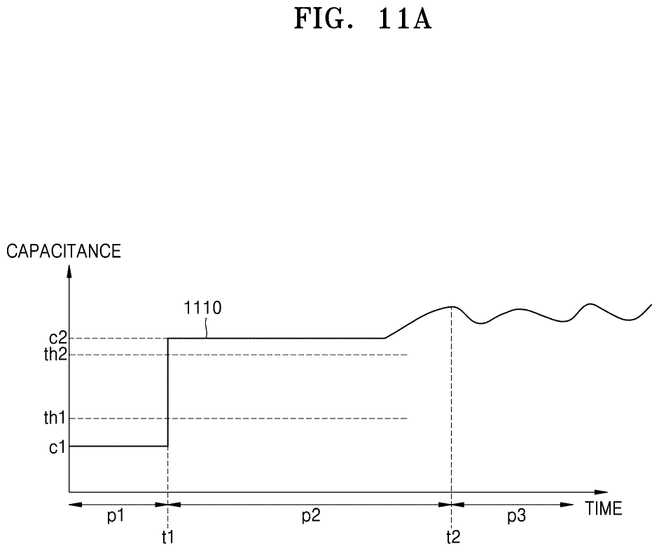

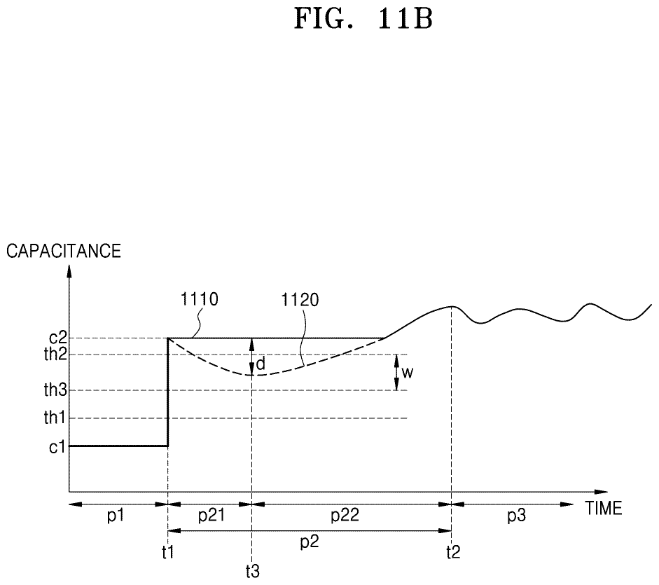

FIGS. 11A and 11B are graphs showing changes in capacitance of a receiving portion according to an embodiment.

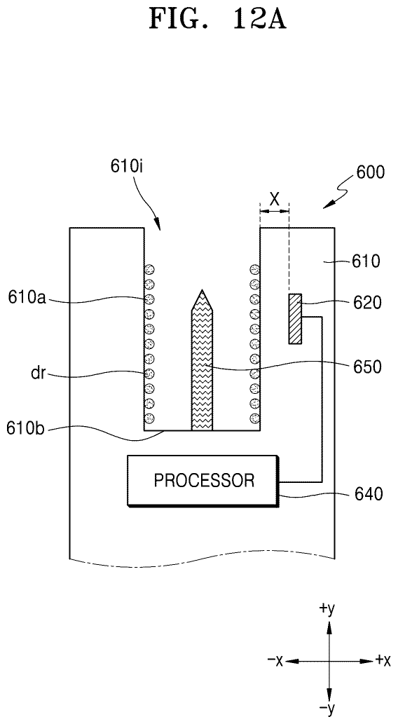

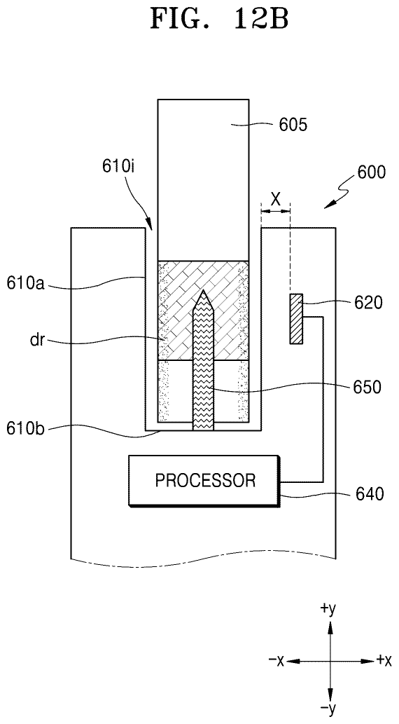

FIGS. 12A and 12B are drawings for explaining the principle by which the capacitance decreases after insertion of an aerosol-generating article.

FIG. 11A illustrates only graph 1110, and FIG. 11B illustrates graph 1110 and graph 1120. Hereinafter, with reference to FIG. 6 and FIGS. 11 to 12, the principle by which the processor 640 determines insertion/removal of the aerosol-generating article 605 based on a sensing signal of the sensor 620 will be described.

The graphs 1110 and 1120 show changes in capacitance of the receiving portion 610i before/after the aerosol-generating article 605 is inserted into the receiving portion 610i. After a first time point t1 when the aerosol-generating article 605 is inserted into the receiving portion 610i, the processor 640 controls the power supplied to the heater 650 so that the heater 650 performs a preheating operation, and the aerosol-generating article 605 inserted into the receiving portion 610i is heated by the heater 650 that performs the preheating operation.

The y-axis of each of the graphs 1110 and 1120 represents the capacitance of the receiving portion 610i, and the x-axis of each of the graphs 1110 and 1120 represents time. The capacitance of the receiving portion 610i may be determined based on the time for one charge of the sensor 620, the time for one discharge of the sensor 620, the time for one charge and discharge of the sensor 620, the number of charges per unit time, the number of discharges per unit time, or the number of completed charges and discharges per unit time, etc. The time constant, which is a measure of the time for the sensor 620 to be charged or discharged, is proportional to the capacitance of the receiving portion 610i detected by the sensor 620. Therefore, it may be said that the charging/discharging speed of the sensor 620 has an inverse relationship with the capacitance, that is, an inverse proportion relationship.

The graph 1110 assumes an ideal situation, in which no material having a certain permittivity remains in the receiving portion 610i before the aerosol-generating article 605 is inserted into the receiving portion 610i.

The graph 1120 represents a case in which a material having a certain permittivity remains in the receiving portion 610i before the aerosol-generating article 605 is inserted into the receiving portion 610i. The material having a certain permittivity corresponds to, for example, a case in which an aerosol (or droplet) generated from an aerosol-generating article 605 inserted before or immediately before an aerosol-generating article to be currently inserted is formed as a residue on the wall surface of the receiving portion 610i.

For convenience of explanation, it is assumed that the graph 1120 differs from the graph 1110 in a period p2 and does not differ from the graph 1110 in a period p1 and a period p3.

First, the graph 1110 is described.

In the period p1, the capacitance of the receiving portion 610i has a value c1. The period p1 is a period before the first time point t1 when the aerosol-generating article 605 is inserted into the receiving portion 610i, and in the period p1, the receiving portion 610i has a capacitance in a state in which the receiving portion 610i is empty. As described above, the capacitance of the receiving portion 610i is inversely proportional to the charging/discharging speed of the sensor 620.

The period p2 is a period between the first time point t1 and a second time point t2 when the aerosol-generating article 605 is inserted into the receiving portion 610i. When an aerosol-generating article 605 having a relatively high permittivity compared to the permittivity of air is inserted into the receiving portion 610i, the capacitance of the receiving portion 610i has a value c2 that is greater than the value c1. From a point in time in the period p2, the aerosol-generating article 605 inserted into the receiving portion 610i is heated by the heater 650 performing a preheating operation. As the aerosol-generating article 605 is heated by the heater 650 performing the preheating operation, the temperature of an aerosol-generating material having a permittivity increases, and the permittivity of the aerosol-generating material increases further due to the temperature increase. As a result, the capacitance of the receiving portion 610i in the latter half of the period p2 increases more than the capacitance value c2 immediately after the aerosol-generating article 605 is inserted.

The period p3 is a smoking period after the preheating is completed. In the period p3, the capacitance of the receiving portion 610i may repeatedly increase and decrease due to the influence of the user's puff. The reason why the increase and decrease of the capacitance of the receiving portion 610i in the period p3 is repeated is that the temperature of the receiving portion 610i may change when the user puffs and the amount of the aerosol-generating material having a permittivity inserted into the receiving portion 610i may change as the aerosol-generating material is inhaled by the user.

The capacitance of the receiving portion 610i changes depending on whether the aerosol-generating article 605 is inserted. Therefore, by comparing the capacitance of the receiving portion 610i with a reference value, whether the aerosol-generating article 605 is inserted may be determined.

Considering noise included in the sensor 620, it is preferable that a reference value for determining the insertion of the aerosol-generating article 605 be set differently from a reference value for determining the removal of the aerosol-generating article 605. The processor 640 according to a first embodiment determines that the aerosol-generating article 605 is inserted into the receiving portion 610i when the capacitance of the receiving portion 610i exceeds a first reference value th1. In addition, after the processor 640 determines that the aerosol-generating article 605 is inserted into the receiving portion 610i, when the capacitance of the receiving portion 610i is less than a second reference value th2, the processor 640 determines that the aerosol-generating article 605 is removed from the receiving portion 610i. The second reference value th2 has a different value than the first reference value th1 and may have a value greater than the first reference value th1.

Next, the graph 1120 will be described with reference to FIG. 11B.

The inventors of the disclosure have found that, in the case of the first embodiment, the processor 640 misjudges the removal of the aerosol-generating article 605.

The reason why the removal of the aerosol-generating article 605 is misjudged in the case of the first embodiment is explained with reference to FIGS. 11B and 12.

FIG. 12A illustrates a state in which, after the user has finished smoking the aerosol-generating article 605, the aerosol-generating article 605 is removed from the receiving portion 610i and some of the aerosol remains in the receiving portion 610i in the form of a droplet dr.

The receiving portion 610i may be configured to have a cylinder shape including a side surface 610a and a bottom surface 610b. The aerosol is generated from the aerosol-generating article through heating by the heater 650 and is mostly inhaled by the user. However, some of the aerosol generated from the aerosol-generating article may not be inhaled by the user, but may remain in the form of the droplet dr on the side surface 610a or the bottom surface 610b of the receiving portion 610i. Because the droplet dr has a relatively high permittivity compared to the permittivity of air, the droplet dr may affect the capacitance of the receiving portion 610i.

FIG. 12B illustrates a state in which the aerosol-generating article 605 is inserted into the receiving portion 610i following the state of FIG. 12A. When the aerosol-generating article 605 is inserted into the receiving portion 610i, the droplet dr remaining on the side surface 610a or the bottom surface 610b of the receiving portion 610i may be absorbed by the aerosol-generating article 605, and the position of the droplet dr may move from the side surface 610a of the receiving portion 610i toward the center of the receiving portion 610i. The capacitance of the receiving portion 610i may be affected by the permittivity of the droplet dr as well as the distance between the droplet dr and the sensor 620. Therefore, when the droplet dr remaining on the side surface 610a or the bottom surface 610b of the receiving portion 610i moves to the aerosol-generating article 605 inserted into the receiving portion 610i and is absorbed, the capacitance of the receiving portion 610i may change due to a change in the distance between the droplet dr and the sensor 620.

Referring to FIG. 11B, the graph 1120 has a downward convex graph shape in the period p2, unlike the graph 1110. Specifically, the capacitance of the receiving portion 610i gradually decreases in a period p21 and then increases again in a period p22. In the period p2, the capacitance of the receiving portion 610i has a minimum value at a third time point t3 and has a value of “c2-d” that is less than the value c2 by d.

It is presumed that the reason why the capacitance of the receiving portion 610i decreases in the period p21 is that, as described with reference to FIG. 12B, the droplet dr remaining on the side surface 610a or the bottom surface 610b of the receiving portion 610i is absorbed by and moved to the aerosol-generating article 605 inserted into the receiving portion 610i, thereby changing the distance between the droplet dr and the sensor 620.

It is presumed that the reason why the capacitance of the receiving portion 610i increases again in the period p22 is that the droplet dr remaining in the receiving portion 610i is vaporized and removed while the heater 650 is preheating, or the droplet dr absorbed by the aerosol-generating article 605 is vaporized and removed. In addition, as the aerosol-generating article 605 is heated by the heater 650 performing the preheating operation, the temperature of an aerosol-generating material having a permittivity increases, and the permittivity of the aerosol-generating material increases further due to the temperature increase. As a result, the capacitance of the receiving portion 610i in the latter half of the period p22 increases more than the capacitance value c2 immediately after the aerosol-generating article 605 is inserted.

As described in the first embodiment, when the capacitance of the receiving portion 610i is less than the second reference value th2, it may be determined that the aerosol-generating article 605 is removed from the receiving portion 610i. However, as seen in the graph 1120, due to the influence of the droplet dr remaining in the receiving portion 610i, the capacitance of the receiving portion 610i has a pattern (a downward convex pattern) in which the capacitance decreases and then increases again in the period p2. As illustrated in the graph 1120, when the value of “c2-d”, which is the capacitance value of the receiving portion 610i at the third time point t3, is less than the second reference value th2, according to the first embodiment, the aerosol-generating article 605 may be erroneously determined to be removed from the receiving portion 610i even though the aerosol-generating article 605 has not been removed from the receiving portion 610i. Therefore, in order to increase the accuracy of determining the removal of the aerosol-generating article 605 in a preheating period included in at least the period p2, it is necessary to adjust the second reference value th2 by considering a change in capacitance of the receiving portion 610i due to the movement of the droplet dr.

The processor 640 according to a second embodiment may adjust a reference value for determining that the aerosol-generating article 605 is removed from the receiving portion 610i in the preheating period. Specifically, the processor 640 determines that the aerosol-generating article 605 is removed from the receiving portion 610i when the capacitance of the receiving portion 610i in the preheating period is less than a third reference value th3 obtained by subtracting a value w from the second reference value th2. In contrast, in the smoking period, the processor 640 may determine that the aerosol-generating article 605 is removed from the receiving portion 610i when the capacitance of the receiving portion 610i is less than the second reference value th2.

However, in order to increase the accuracy of determining the removal of the aerosol-generating article 605, the third reference value th3 may not be lowered below the second reference value th2 without a lower limit. As described above, considering noise included in the sensor 620, it is preferable that a reference value for determining the insertion of the aerosol-generating article 605 be set differently from a reference value for determining the removal of the aerosol-generating article 605. Therefore, it is preferable that the second reference value th2 be set to a value at least higher than the first reference value th1. That is, it is preferable that the value w be set to be greater than 0 and be less than the difference (th2−th1) between the first reference value th1 and the second reference value th2

The value w may be determined corresponding to a width d of the decrease in the capacitance of the receiving portion 610i in the period p2. In an embodiment, the value w may be determined in proportion to the width d of the decrease in the capacitance of the receiving portion 610i in the period p2. In another embodiment, the value w may be determined to be the same value as the width d of the decrease in the capacitance of the receiving portion 610i in the period p2. The width d of the decrease in the capacitance of the receiving portion 610i in the period p2 may be proportional to the amount of droplet dr remaining in the receiving portion 610i before the aerosol-generating article 605 is inserted into the receiving portion 610i. As a result, the value w may be set based on the amount of droplet dr remaining in the receiving portion 610i before the aerosol-generating article 605 is inserted into the receiving portion 610i.

In an embodiment, the processor 640 may set the value w in proportion to the time interval between the last puff time point for another aerosol-generating article 605 inserted immediately before the aerosol-generating article 605 is inserted and the heating end time point for the another aerosol-generating article 605 inserted immediately before the aerosol-generating article 605 is inserted. This is because the longer the time interval between the last puff time point for another aerosol-generating article 605 inserted immediately before the aerosol-generating article 605 is inserted and the heating end time point for the other aerosol-generating article 605 inserted immediately before the aerosol-generating article 605 is inserted, the greater the amount of droplet dr remaining in the receiving portion 610i. In this specification, another aerosol-generating article 605 is referred to as a different aerosol-generating article 605 to distinguish it from the aerosol-generating article 605 inserted at the current point in time, and means the previous aerosol-generating article 605 inserted immediately before the current aerosol-generating article 605 is inserted.

In an embodiment, the processor 640 may set the value w in inverse proportion to the total number of puffs for another aerosol-generating article 605 inserted immediately before the aerosol-generating article 605 is inserted. When the total number of puffs for another aerosol-generating article 605 inserted immediately before the aerosol-generating article 605 is inserted is large, most of the aerosol generated from the aerosol-generating article 605 is inhaled by the user, and the amount of aerosol left in the form of droplet dr in the receiving portion 610i may be relatively small.

In an embodiment, the processor 640 may set the value w in inverse proportion to the time interval between the heating end time point for another aerosol-generating article 605 inserted immediately before the aerosol-generating article 605 is inserted and the time point of the insertion of the aerosol-generating article 605. This is because the longer the time interval between the heating end time point for another aerosol-generating article 605 inserted immediately before the aerosol-generating article 605 is inserted and the time point of the insertion of the aerosol-generating article 605, the more the droplet dr remaining in the receiving portion 610i may be vaporized and removed.

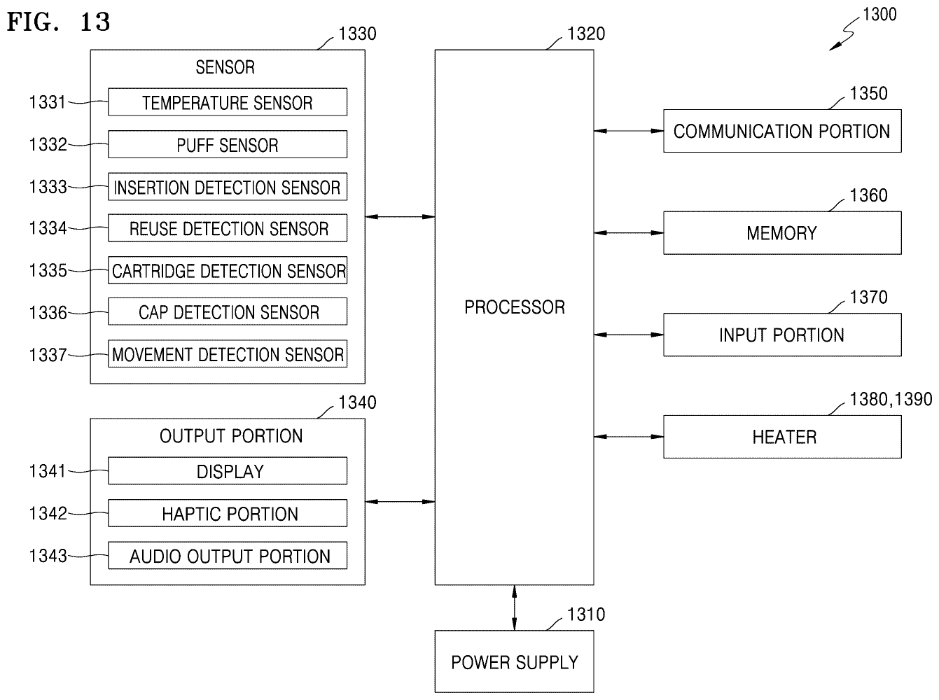

FIG. 13 is a block diagram of an aerosol-generating device according to an embodiment.

FIG. 13 is a block diagram of an aerosol-generating device 1300 according to an embodiment.

The aerosol-generating device 1300 may include a power supply 1310, a processor 1320, a sensor 1330, an output portion 1340, a communication portion 1350, a memory 1360, an input portion 1370, and at least one heater (i.e., a heater 1380 or a cartridge heater 1390). However, the internal structure of the aerosol-generating device 1300 is not limited to that illustrated in FIG. 13. That is, depending on the design of the aerosol-generating device 1300, some of the configurations illustrated in FIG. 13 may be omitted or new configurations may be added, as will be understood by those skilled in the art related to the present embodiment. The processor 1320 may be configured as a component of the controller 12 described with reference to FIGS. 1 to 3.

The sensor 1330 may detect the state of the aerosol-generating device 1300 or the state around the aerosol-generating device 1300 and transmit detected information to the processor 1320. Based on the detected information, the processor 1320 may control the aerosol-generating device 1300 so that various functions, such as controlling the operation of the cartridge heater 1390 and/or the heater 1380, restricting smoking, determining whether an aerosol-generating article and/or a cartridge is inserted, and displaying a notification, are performed.

The sensor 1330 may include at least one of a temperature sensor 1331, a puff sensor 1332, an insertion detection sensor 1333, a reuse detection sensor 1334, a cartridge detection sensor 1335, a cap detection sensor 1336, and a movement detection sensor 1337.

The temperature sensor 1331 may detect the temperature at which the cartridge heater 1390 and/or the heater 1380 is heated. The aerosol-generating device 1300 may include a separate temperature sensor that detects the temperature of the cartridge heater 1390 and/or the heater 1380, or the cartridge heater 1390 and/or the heater 1380 itself may function as a temperature sensor.

The temperature sensor 1331 may output a signal corresponding to the temperature of the cartridge heater 1390 and/or the heater 1380. For example, the temperature sensor 1331 may include a resistance element whose resistance value changes in response to a change in the temperature of the cartridge heater 1390 and/or the heater 1380. The resistance element may be implemented by a thermistor, which is an element that utilizes the property of changing resistance depending on temperature. In this case, the temperature sensor 1331 may output a signal corresponding to the resistance value of the resistance element as a signal corresponding to the temperature of the cartridge heater 1390 and/or the heater 1380.

The temperature sensor 1331 may be placed around the power supply 1310 to monitor the temperature of the power supply 1310.

The puff sensor 1332 may detect the user's puff based on various physical changes in an airflow path. The puff sensor 926 may detect the user's puff based on any one of temperature change, flow change, voltage change, and pressure change. The puff sensor 1332 may output a signal corresponding to the puff. For example, the puff sensor 1332 may be a pressure sensor. The puff sensor 1332 may output a signal corresponding to the internal pressure of the aerosol-generating device 1300. In this case, the internal pressure of the aerosol-generating device 1300 may correspond to the pressure of an airflow path through which gas flows. The puff sensor 1332 may be arranged to correspond to the airflow path through which the gas flows in the aerosol-generating device 1300.

The insertion detection sensor 1333 may detect whether an aerosol-generating article (e.g., the aerosol-generating article 2 of FIGS. 1 to 3) is inserted into and/or removed from a receiving portion. The insertion detection sensor 1333 may detect a signal change according to the insertion and/or removal of the aerosol-generating article. The insertion detection sensor 1333 may be installed around the receiving portion. The insertion detection sensor 1333 may detect the insertion and/or removal of the aerosol-generating article according to a change in capacitance inside the receiving portion. For example, the insertion detection sensor 1333 may be an inductive sensor. The insertion detection sensor 1333 may be a capacitance sensor that detects the capacitance inside the receiving portion, and may be the sensor 620 of FIG. 6 or the sensor 1020 of FIG. 10.

The inductive sensor may include at least one coil. The coil of the inductive sensor may be arranged adjacent to the receiving portion.

The capacitance sensor may include a conductor. The conductor of the capacitance sensor may be arranged adjacent to the receiving portion. The capacitance sensor may output a signal corresponding to the electromagnetic properties of the surroundings thereof, for example, the capacitance around the conductor. For example, when an aerosol-generating article having a relatively high permittivity compared to the permittivity of air is inserted into the receiving portion, the electromagnetic properties around the conductor may change.

The reuse detection sensor 1334 may detect whether the aerosol-generating article has been reused. The reuse detection sensor 1334 may be a color sensor. The color sensor may detect the color of the aerosol-generating article. The color of at least some of the wrappers constituting the aerosol-generating article may be changed by the aerosol.

The cartridge detection sensor 1335 may detect the mounting and/or removal of a cartridge. The cartridge detection sensor 1335 may be implemented by an inductance-based sensor, a capacitive sensor, a resistance sensor, a hall sensor (i.e., a hall integrated circuit (IC)) using the hall effect, etc.

The cap detection sensor 1336 may detect the mounting and/or removal of a cap. When a cap is separated from a body, portions of the cartridge and the body covered by the cap may be exposed to the outside. The cap detection sensor 1336 may be implemented by a contact sensor, a hall sensor (i.e., a hall IC), an optical sensor, etc.

The movement detection sensor 1337 may detect the movement of the aerosol-generating device. The movement detection sensor 1337 may be implemented by at least one of an acceleration sensor and a gyro sensor.

In addition to the sensors 1331 to 1337 described above, the sensor 1330 may further include at least one of a humidity sensor, a pressure sensor, a magnetic sensor, a position sensor (i.e., a global positioning system (GPS)), and a proximity sensor. Because the function of each sensor may be intuitively inferred by a person skilled in the art from its name, a detailed description thereof may be omitted.

The output portion 1340 may output information on the state of the aerosol-generating device 1300 and provide the information to the user. The output portion 1340 may include at least one of a display 1341, a haptic portion 1342, and an audio output portion 1343, but is not limited thereto. When the display 1341 and a touch pad form a layer structure to constitute a touch screen, the display 1341 may be used as an input device in addition to an output device.

The display 1341 may visually provide information about the aerosol-generating device 1300 to the user. For example, the information about the aerosol-generating device 1300 may refer to various pieces of information, such as the charging/discharging status of the power supply 1310 of the aerosol-generating device 1300, the preheating status of the heater 1380, the insertion/removal status of the aerosol-generating article and/or cartridge, the mounting/removal status of the cap, or the status in which the use of the aerosol-generating device 1300 is restricted (e.g., detection of an abnormal article), and the display 1341 may output the information to the outside. For example, the display 1341 may be in the form of a light-emitting diode (LED) that is a light-emitting element. For example, the display 1341 may be a liquid crystal display (LCD) panel, an organic light-emitting display (OLED) panel, etc.

The haptic portion 1342 may convert an electrical signal into a mechanical stimulus or an electrical stimulus to tactilely provide information about the aerosol-generating device 1300 to the user. For example, the haptic portion 1342 may generate vibration corresponding to the completion of the initial preheating when the initial power is supplied to the cartridge heater 1390 and/or the heater 1380 for a set period of time. The haptic portion 1342 may include a vibration motor, a piezoelectric element, or an electrical stimulation device.

The audio output portion 1343 may auditorily provide information about the aerosol-generating device 1300 to the user. For example, the audio output portion 1343 may convert an electrical signal into an audio signal and output the audio signal to the outside.

The power supply 1310 may supply power used to operate the aerosol-generating device 1300. The power supply 1310 may supply power so that the cartridge heater 1390 and/or the heater 1380 may be heated. In addition, the power supply 1310 may supply power required for the operations of other components provided in the aerosol-generating device 1300, such as the sensor 1330, the output portion 1340, the input portion 1370, the communication portion 1350, and the memory 1360. The power supply 1310 may be a rechargeable battery or a disposable battery, such as the battery 11 of the aerosol-generating device 1 described with reference to FIGS. 1 to 3. For example, the power supply 1310 may be a lithium polymer (LiPoly) battery, but is not limited thereto.

Although not shown in FIG. 13, the aerosol-generating device 1300 may further include a power protection circuit. The power protection circuit may be electrically connected to the power supply 1310 and include a switching element.

The power protection circuit may block an electrical path for the power supply 1310 according to a certain condition.

The heater 1380 may receive power from the power supply 1310 and heat a medium or an aerosol-generating material in the aerosol-generating article. The heater 1380 may have the same configuration as one of the heater 13 of FIGS. 1 to 3, the heater 650 of FIG. 6, and the heater 1030 of FIG. 10. The heater 1380 may heat the inside or the outside of the aerosol-generating article.

The processor 1320, the sensor 1330, the output portion 1340, the input portion 1370, the communication portion 1350, and the memory 1360 may receive power from the power supply 1310 and perform their functions. Also, although not shown in FIG. 13, a noise filter may be provided between the power supply 1310 and the heater 1380. The noise filter may be a low pass filter. The low pass filter may include at least one inductor and a capacitor. The cutoff frequency of the low pass filter may correspond to the frequency of a high frequency switching current applied from the power supply 1310 to the heater 1380. By the low pass filter, high frequency noise components may be prevented from being applied to the sensor 1330, such as the insertion detection sensor 1333.

In an embodiment, the cartridge heater 1390 and/or the heater 1380 may include any suitable electrically resistive material.

In another embodiment, the heater 1380 may be an induction heating type heater. For example, the heater 1380 may include a susceptor that heats the aerosol-generating material by generating heat through a magnetic field applied by a coil.

The input portion 1370 may receive information input from a user or output information to the user. For example, the input portion 1370 may be a touch panel.

The display 1341 and the touch panel may be implemented as a single panel.

The input portion 1370 may include, but is not limited to, a button, a key pad, a dome switch, a jog wheel, a jog switch, etc.

The memory 1360 is a hardware component that stores various pieces of data processed within the aerosol-generating device 1300, and may store data processed by the processor 1320 and data to be processed. The memory 1360 may include at least one type of storage medium selected from among a flash memory type, hard disk type, multimedia card micro type, or card type memory (e.g., an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The memory 1360 may store data about the operation time of the aerosol-generating device 1300, the maximum number of puffs, the current number of puffs, at least one temperature profile, and the user's smoking pattern. At least one data among the heating end time point of the aerosol-generating device 1300, the total number of puffs for one aerosol-generating article, and the last puff time point may be stored in the memory 1360.

The communication portion 1350 may include at least one component for communication with other electronic devices. For example, the communication portion 1350 may include at least one of a short-range communication portion and a wireless communication portion.

Although not shown in FIG. 13, the aerosol-generating device 1300 may further include a connection interface, such as a universal serial bus (USB) interface, and may transmit and receive information or charge the power supply 1310 by connecting to another external device through the connection interface, such as the USB interface.

The processor 1320 may control all operations of the aerosol-generating device 1300. In an embodiment, the processor 1320 may include at least one processor. The processor may be implemented as an array of a plurality of logic gates, or may be implemented as a combination of a general-purpose microprocessor and a memory storing a program that may be executed on the microprocessor. In addition, it will be understood by those skilled in the art that the processor may be implemented as other types of hardware.

The processor 1320 may control the temperature of the heater 1380 by controlling the supply of power from the power supply 1310 to the heater 1380. The processor 1320 may control the temperature of the cartridge heater 1390 and/or the heater 1380 based on the temperature of the cartridge heater 1390 and/or the heater 1380 sensed by the temperature sensor 131. The processor 1320 may adjust the power supplied to the cartridge heater 1390 and/or the heater 1380 based on the temperature of the cartridge heater 1390 and/or the heater 1380. For example, the processor 1320 may determine a target temperature for the cartridge heater 1390 and/or the heater 1380 based on a temperature profile stored in the memory 1360.

The aerosol-generating device 1300 may include a power supply circuit (not shown) electrically connected to the power supply 1310 between the power supply 1310 and the cartridge heater 1390 and/or the heater 1380. The power supply circuit may be electrically connected to the cartridge heater 1390 or the heater 1380. The power supply circuit may include at least one switching element. The switching element may be implemented by a bipolar junction transistor (BJT), a field effect transistor (FET), or the like. The processor 1320 may control the power supply circuit.

The processor 1320 may control power supply by controlling the switching of the switching element of the power supply circuit. The power supply circuit may be an inverter that converts direct current power output from the power supply 1310 into alternating current power. For example, the inverter may be configured as a full-bridge circuit or a half-bridge circuit including a plurality of switching elements.

The processor 1320 may turn on the switching elements so that power is supplied from the power supply 1310 to the cartridge heater 1390 and/or the heater 1380. The processor 1320 may turn off the switching elements so that power is cut off from the cartridge heater 1390 and/or the heater 1380. The processor 1320 may control a current supplied from the power supply 1310 by controlling the frequency and/or duty ratio of a current pulse input to the switching elements.

The processor 1320 may control a voltage output from the power supply 1310 by controlling the switching of the switching elements of the power supply circuit. A power conversion circuit may convert the voltage output from the power supply 1310. For example, the power conversion circuit may include a buck converter that steps down the voltage output from the power supply 1310. For example, the power conversion circuit may be implemented using a buck-boost converter, a zener diode, etc.

The processor 1320 may control the on/off operation of a switching element included in the power conversion circuit to adjust the level of a voltage output from the power conversion circuit. When the on state of the switching element continues, the level of the voltage output from the power conversion circuit may correspond to the level of the voltage output from the power supply 1310. The duty ratio for the on/off operation of the switching element may correspond to the ratio of the voltage output from the power conversion circuit to the voltage output from the power supply 1310. As the duty ratio for the on/off operation of the switching element decreases, the level of the voltage output from the power conversion circuit may decrease. The heater 1380 may be heated based on the voltage output from the power conversion circuit.

The processor 1320 may control power to be supplied to the heater 1380 by using at least one of a pulse width modulation PWM method and a proportional-integral-differential (PID) method.

For example, the processor 1320 may control a current pulse having a certain frequency and duty ratio to be supplied to the heater 1380 by using the PWM method. The processor 1320 may control the power supplied to the heater 1380 by adjusting the frequency and duty ratio of the current pulse.

For example, the processor 1320 may determine a target temperature that is a target of control based on a temperature profile. The processor 1320 may control the power supplied to the heater 1380 by using the PID method, which is a feedback control method using the difference value between the temperature of the heater 1380 and a target temperature, the integral value of the difference value over time, and the differential value of the difference value over time.

The processor 1320 may prevent the cartridge heater 1390 and/or the heater 1380 from overheating. For example, the processor 1320 may control the operation of the power conversion circuit so that the supply of power to the cartridge heater 1390 and/or the heater 1380 is stopped based on the temperature of the cartridge heater 1390 and/or the heater 1380 exceeding a preset limit temperature. For example, the processor 1320 may reduce the amount of power supplied to the cartridge heater 1390 and/or the heater 1380 by a certain percentage based on whether the temperature of the cartridge heater 1390 and/or the heater 1380 exceeds a preset limit temperature. For example, the processor 1320 may determine that the aerosol-generating material contained in the cartridge is exhausted based on whether the temperature of the cartridge heater 1390 exceeds a limit temperature, and may cut off power supply to the cartridge heater 1390.

The processor 1320 may control the charging and discharging of the power supply 1310. The processor 1320 may check the temperature of the power supply 1310 based on an output signal of the temperature sensor 131.

When a power line is connected to a battery terminal of the aerosol-generating device 1300, the processor 1320 may check whether the temperature of the power supply 1310 is equal to or higher than a first limit temperature, which is a criterion for blocking charging of the power supply 1310. When the temperature of the power supply 1310 is lower than the first limit temperature, the processor 1320 may control the power supply 1310 to be charged based on a preset charging current. When the temperature of the power supply 1310 is equal to or higher than the first limit temperature, the processor 1320 may block charging of the power supply 1310.

When the power of the aerosol-generating device 1300 is turned on, the processor 1320 may check whether the temperature of the power supply 1310 is equal to or higher than a second limit temperature, which is a criterion for blocking discharging of the power supply 1310. The processor 1320 may control the power stored in the power supply 1310 to be used when the temperature of the power supply 1310 is less than the second limit temperature. The processor 1320 may stop using the power stored in the power supply 1310 when the temperature of the power supply 1310 is equal to or higher than the second limit temperature.

The processor 1320 may calculate the remaining capacity of the power stored in the power supply 1310. For example, the processor 1320 may calculate the remaining capacity of the power supply 1310 based on voltage and/or current sensing values of the power supply 1310.

The processor 1320 may determine whether an aerosol-generating article is inserted into the receiving portion, through the insertion detection sensor 1333. The processor 1320 may determine that an aerosol-generating article is inserted, based on an output signal of the insertion detection sensor 1333. If it is determined that an aerosol-generating article is inserted into the receiving portion, the processor 1320 may control power to be supplied to the cartridge heater 1390 and/or the heater 1380. For example, the processor 1320 may supply power to the cartridge heater 1390 and/or the heater 1380 based on a temperature profile stored in the memory 1360.

The processor 1320 may determine whether an aerosol-generating article is removed from the receiving portion. For example, the processor 1320 may determine whether an aerosol-generating article is removed from the receiving portion, through the insertion detection sensor 1333. For example, the processor 1320 may determine that an aerosol-generating article is removed from the receiving portion when the capacitance of the receiving portion that receives the aerosol-generating article is less than a reference value.

In an embodiment, if it is determined that an aerosol-generating article has been removed from the receiving portion, the processor 1320 may cut off the supply of power to the cartridge heater 1390 and/or the heater 1380.

In another embodiment, if it is determined that an aerosol-generating article has been removed from the receiving portion, a cleaning operation for the heater 1380 may be controlled. Specifically, if it is determined that an aerosol-generating article has been removed from the receiving portion, the processor 1320 may control power supply to the heater 1380 so that the heater 1380 is heated to a temperature higher than target temperatures of a preheating period and a smoking period after a preset time. Specifically, a heating temperature of the heater 1380 for the cleaning operation may be higher than a heating temperature of the heater 1380 for heating the aerosol-generating article. For example, in order to perform the cleaning operation, the processor 1320 may control power supply so that the heater 1380 has a temperature range of about 450° C. to about 550° C. More preferably, in order to perform the cleaning operation, the processor 1320 may control power supply so that the heater 1380 has a temperature range of about 500° C. to about 550° C. However, the heating temperature range for performing the cleaning operation for the heater 1380 is exemplary and may be variously changed according to the design of the manufacturer.

The processor 1320 may control the power supply time and/or power supply amount for the heater 1380 according to the state of the aerosol-generating article detected by the sensor 1330. The processor 1320 may check a level range that includes the level of a signal of the capacitance sensor, based on a lookup table. The processor 1320 may determine the moisture content of the aerosol-generating article according to the checked level range.

In the case where the aerosol-generating article is in an over-moisture state, the processor 1320 may control the power supply time to the heater 1380 to increase the preheating time of the aerosol-generating article compared to a normal state.

The processor 1320 may determine whether the aerosol-generating article inserted into the receiving portion is reused, through the reuse detection sensor 1334. For example, the processor 1320 may compare a sensing value of a signal of the reuse detection sensor with a first reference range including a first color, and when the sensing value is included in the first reference range, the processor 1320 may determine that the aerosol-generating article is not used. For example, the processor 1320 may compare the sensing value of the signal of the reuse detection sensor with a second reference range including a second color, and when the sensing value is included in the second reference range, the processor 1320 may determine that the aerosol-generating article is used. If it is determined that the aerosol-generating article has been used, the processor 1320 may cut off the power supply to the cartridge heater 1390 and/or the heater 1380.

The processor 1320 may determine whether the cartridge is coupled and/or removed, through the cartridge detection sensor 1335. For example, the processor 1320 may determine whether the cartridge is coupled and/or removed, based on a sensing value of a signal of the cartridge detection sensor.

The processor 1320 may determine whether the aerosol-generating material of the cartridge is exhausted. For example, the processor 1320 may preheat the cartridge heater 1390 and/or the heater 1380 by applying power thereto, determine whether the temperature of the cartridge heater 1390 exceeds a limit temperature during the preheating period, and if the temperature of the cartridge heater 1390 exceeds the limit temperature, determine that the aerosol-generating material of the cartridge is exhausted. If it is determined that the aerosol-generating material of the cartridge is exhausted, the processor 1320 may cut off the power supply to the cartridge heater 1390 and/or the heater 1380.

The processor 1320 may determine whether the cartridge is usable. For example, if the current number of puffs is greater than or equal to the maximum number of puffs set for the cartridge based on data stored in the memory 1360, the processor 1320 may determine that the cartridge is unusable. For example, when the total time during which the heater 1390 has been heated is greater than or equal to a preset maximum time or the total amount of power supplied to the heater 1390 is greater than or equal to a preset maximum amount of power, the processor 1320 may determine that the cartridge is unusable.

The processor 1320 may perform a judgment regarding the user's inhalation through the puff sensor 1332. For example, the processor 1320 may determine whether a puff has occurred, based on a sensing value of a signal of the puff sensor 1332. For example, the processor 1320 may determine the intensity of the puff based on the sensing value of the signal of the puff sensor 1332. When the number of puffs reaches a preset maximum number of puffs or when no puffs are detected for a preset time or longer, the processor 1320 may cut off the supply of power to the cartridge heater 1390 and/or the heater 1380.

The processor 1320 may determine whether a puff has occurred, based on a sensing value of the insertion detection sensor 1333. The aerosol-generating material inserted into the receiving portion has a permittivity, and when the user's puff occurs, the aerosol-generating material inserted into the receiving portion decreases and the capacitance of the receiving portion changes. Specifically, when the insertion detection sensor 1333 is configured with a capacitance, the processor 1320 may determine that the user's puff has occurred when the slope of the change in the charging time or the discharging time of the insertion detection sensor 1333 has a negative value and the absolute value thereof exceeds a reference value. Alternatively, the processor 640 may determine that the user's puff has occurred when the amount of change in the charging or discharging time of the insertion detection sensor 1333 decreases to a value greater than or equal to a reference value.

The processor 1320 may determine whether a puff has occurred, based on a sensing value of the temperature sensor 1331 that measures the temperature of the heater 1380. When the user's puff occurs, the temperature of the heater 1380 may decrease momentarily as external air is drawn in, and the processor 1320 may determine that the user's puff has occurred when the change in the temperature decrease of the heater 1380 is greater than or equal to a reference value.

The processor 1320 may determine whether a cap is coupled and/or removed, through the cap detection sensor 1336. For example, the processor 1320 may determine whether the cap is coupled and/or removed, based on a sensing value of a signal of the cap detection sensor 1336.

The processor 1320 may control the output portion 1340 based on a result detected by the sensor 1330. For example, when the number of puffs counted through the puff sensor 1332 reaches a preset number, the processor 1320 may notify the user through at least one of the display 1341, the haptic portion 1342, and the audio output portion 1343 that the aerosol-generating device 1300 will soon be terminated. For example, the processor 1320 may notify the user through the output portion 1340 based on a determination that no aerosol-generating article exists in the receiving portion. For example, the processor 1320 may notify the user through the output portion 1340 based on a determination that the cartridge and/or cap is not mounted. For example, the processor 1320 may transmit information about the temperature of the cartridge heater 1390 and/or the heater 1380 to the user through the output portion 1340.

The processor 1320 may store and update a history of an event that has occurred in the memory 1360 based on the occurrence of a certain event. The event may include operations, such as detection of insertion of an aerosol-generating article, initiation of heating of the aerosol-generating article, detection of a puff, termination of a puff, detection of overheating of the cartridge heater 1390 and/or the heater 1380, detection of application of overvoltage to the cartridge heater 1390 and/or the heater 1380, termination of heating of the aerosol-generating article, turning on/off the power of the aerosol-generating device 1300, initiation of charging of the power supply 1310, detection of overcharge of the power supply 1310, and termination of charging of the power supply 1310, which are performed in the aerosol-generating device 1300. The history of the event may include the time when the event occurred, log data corresponding to the event, etc. For example, when a certain event is detection of insertion of an aerosol-generating article, log data corresponding to the event may include data on a sensing value of the insertion detection sensor 1333, etc. For example, when a certain event is detection of overheating of the cartridge heater 1390 and/or the heater 1380, log data corresponding to the event may include data on the temperature of the cartridge heater 1390 and/or the heater 1380, the voltage applied to the cartridge heater 1390 and/or the heater 1380, the current flowing through the cartridge heater 1390 and/or the heater 1380, etc.

The processor 1320 may control forming a communication link with an external device, such as the user's mobile terminal.

The embodiments or other embodiments described above are not mutually exclusive or distinct. The configurations or functions of the embodiments or other embodiments described above may be used together or combined with each other.

For example, it means that a configuration A described in a certain embodiment and/or drawing and a configuration B described in another embodiment and/or drawing may be combined with each other. That is, even when a combination between components is not directly described, it means that a combination is possible, except in cases where a combination is described as impossible.

The above detailed description should not be construed as limiting in all aspects, but should be considered as illustrative. The scope of the disclosure should be determined by a reasonable interpretation of the appended claims, and all changes within the equivalent scope of the disclosure are included in the scope of the disclosure.

According to various embodiments, various controls may be performed by detecting a change in capacitance of a receiving portion into which an aerosol-generating article is inserted.

What is claimed is:

1. An aerosol-generating device comprising:
a housing including a receiving portion into which an aerosol-generating article is inserted;
a heater configured to heat the aerosol-generating article inserted into the receiving portion;
a sensor arranged apart from the aerosol-generating article inserted into the receiving portion and configured to generate a sensing signal corresponding to a change in capacitance of the receiving portion; and
a processor electrically connected to the heater and the sensor and configured to control power supplied to the heater based on a temperature profile including a preheating period and a smoking period,
wherein the processor is further configured to:
receive the sensing signal from the sensor,
determine that the aerosol-generating article has been inserted into the receiving portion when the capacitance of the receiving portion exceeds a first reference value, and
after determining that the aerosol-generating article has been inserted, determine that the aerosol-generating article has been removed from the receiving portion when the capacitance of the receiving portion is less than a second reference value that is greater than the first reference value.

2. The aerosol-generating device of claim 1, wherein the processor is further configured to:
determine that the aerosol-generating article has been removed from the receiving portion when the capacitance of the receiving portion is less than a third reference value obtained by subtracting a value w from the second reference value in the preheating period, and
determine that the aerosol-generating article has been removed from the receiving portion when the capacitance of the receiving portion is less than the second reference value in the smoking period.

3. The aerosol-generating device of claim 2, wherein the value w is greater than 0 and less than a difference between the first reference value and the second reference value.

4. The aerosol-generating device of claim 2, wherein the processor is further configured to set the value w in proportion to a time interval between a last puff time point for another aerosol-generating article inserted immediately before the aerosol-generating article is inserted and a heating end time point for the other aerosol-generating article inserted immediately before the aerosol-generating article is inserted.

5. The aerosol-generating device of claim 2, wherein the processor is further configured to set the value w in inverse proportion to a total number of puffs for another aerosol-generating article inserted immediately before the aerosol-generating article is inserted.

6. The aerosol-generating device of claim 2, wherein the processor is further configured to set the value w in inverse proportion to a time interval between a heating end time point for another aerosol-generating article inserted immediately before the aerosol-generating article is inserted and a time point of insertion of the aerosol-generating article.

7. The aerosol-generating device of claim 1, wherein the sensor includes an electrode arranged to be apart from the aerosol-generating article inserted into the receiving portion and positioned to correspond to at least one area of the aerosol-generating article.

8. The aerosol-generating device of claim 7, wherein the processor is further configured to obtain at least one of a charging time and a discharging time of the electrode per unit number of times and calculate the capacitance of the receiving portion.

9. The aerosol-generating device of claim 7, wherein the processor is further configured to obtain at least one of a number of charges and a number of discharges of the electrode per unit time and calculate the capacitance of the receiving portion.

10. The aerosol-generating device of claim 7, wherein the electrode is positioned to correspond to at least one area where an aerosol-generating material of the aerosol-generating article is placed as the aerosol-generating article is inserted.

11. The aerosol-generating device of claim 1, wherein the processor is further configured to supply power to the heater for preheating when the aerosol-generating article is inserted.

12. The aerosol-generating device of claim 1, wherein the processor is further configured to control the power supplied to the heater so that the heater is heated to a temperature higher than target temperatures of the preheating period and the smoking period after a preset time, when it is determined that the aerosol-generating article has been removed.

13. The aerosol-generating device of claim 1, wherein the heater includes:
a coil configured to generate an alternating magnetic field; and
a susceptor configured to generate heat by a magnetic field generated from the coil and heat the aerosol-generating article inserted into the receiving portion.

14. The aerosol-generating device of claim 13, wherein the sensor is arranged between the receiving portion and the coil.

15. The aerosol-generating device of claim 1, wherein the processor is further configured to control the power supplied to the heater to be cut off when it is determined that the aerosol-generating article has been removed.
